(19) United States
(12) Patent Application Publication
(10) Pub. No.: US 2018/0276699 A1
(43) Pub. Date: Sep. 27, 2018

(54) ELECTRONIC SAVINGS CONVERSION AND REDEMPTION IN A POINT OF SALE ENVIRONMENT

(71) Applicant: Walmart Apollo, LLC, Bentonville, AR (US)

(72) Inventors: Sridhar R. Leekkala, Bentonville, AR (US); Mounika Challagundla, Bentonville, AR (US); Jason Roop, Bentonville, AR (US); Pooja Krunal Modi, Bentonville, AR (US)

(21) Appl. No.: 15/925,869

(22) Filed: Mar. 20, 2018

Related U.S. Application Data
(60) Provisional application No. 62/475,594, filed on Mar. 23, 2017.

(51) Int. Cl. G06Q 30/02; G06Q 20/32; G06Q 20/40; G06Q 20/20

(52) U.S. Cl. CPC G06Q 30/0215; G06Q 30/0222; G06Q 20/20; G06Q 20/3274; G06Q 20/4012; G06Q 30/0225

(57) ABSTRACT

Methods and systems for electronic customer savings redemption from an electronic customer savings account associated with a customer may be provided. The electronic customer savings redemption may be available at both a point of sale environment and an e-commerce environment from the electronic customer savings account. A method may include providing a customer indication via a graphical user interface at the point of sale environment. The point of sale environment may be in communication with a cloud-based customer savings redemption system. The customer indication may prompt a customer to provide customer identification information usable to identify the electronic customer savings account associated with the customer. The method may further include receiving the customer identification information at the cloud-based customer savings redemption system and identifying the electronic customer savings account associated with the customer based on the customer identification information.

### RELATED APPLICATIONS

This application claims the benefit of U.S. Provisional Patent Application No. 62/475,594, filed Mar. 23, 2017 and entitled “Electronic Savings Conversion and Redemption in a Point of Sale Environment”, the contents of which are incorporated herein in their entirety.

### TECHNICAL FIELD

The technical field may generally relate to transactions in a point of sale environment, and more particularly to electronically converting and redeeming savings for use in the point of sale environment.

### BACKGROUND

A company or business may allow customers to pay for products or services in a transaction at a retail store or over the Internet. There may be a variety of different ways for the customer to provide funds for payment and for the company or business to receive the funds in exchange for the product or service, including, for example, by cash, check, or credit card. These forms of payment may suffice for many transactions, however, various alternative sources of funds for the customer may not be easily accessible for use in transactions in point of sale environments. Customers and businesses alike may desire to make those alternative sources of funds accessible or more easily accessible for use in point of sale environments. Thus, there may be a need for methods and systems which facilitate accessibility to alternative sources of funds for use in point of sale environments.

### BRIEF SUMMARY

In an embodiment, a method for electronic customer savings redemption from an electronic customer savings account associated with a customer may be provided. The electronic customer savings redemption may be available at both a point of sale environment and an e-commerce environment from the electronic customer savings account. The method may include providing a customer indication via a graphical user interface at the point of sale environment. The point of sale environment may be in communication with a cloud-based customer savings redemption system. The customer indication may prompt a customer to provide customer identification information usable to identify the electronic customer savings account associated with the customer. The method may further include receiving the customer identification information at the cloud-based customer savings redemption system and identifying the electronic customer savings account associated with the customer based on the customer identification information. The method may also include receiving a redemption indication via the graphical user interface at the point of sale environment. The redemption indication may indicate that the customer chose to redeem at least a portion of electronic customer savings associated with the electronic customer savings account. The method may additionally include converting, at the cloud-based customer savings redemption system, the at least a portion of electronic customer savings associated with the electronic customer savings account into an electronic gift card usable at both the point of sale environment and the e-commerce environment. Moreover, the method may include transmitting electronic gift card details associated with the electronic gift card to the point of sale environment and applying the electronic gift card against a transaction for the customer at the point of sale environment.

In an implementation, the electronic customer savings associated with the electronic customer savings account may be accrued from a difference in a first price paid by the customer to a first entity in exchange for a product and a second price offered by a second entity for the product. The difference in the first price and the second price may be the at least a portion of electronic customer savings associated with the electronic customer savings account that is converted into the electronic gift card usable at both the point of sale environment and the e-commerce environment. The electronic customer savings redemption from the electronic customer savings account may be available at a register in a retail store, a website of the retail store, and a mobile application of the retail store via the electronic gift card.

In an implementation, the method may further include receiving the customer identification information from a mobile device associated with the customer. The customer identification information may be included in a QR code including information usable to identify the electronic customer savings account associated with the customer and convert the at least a portion of electronic customer savings associated with the electronic customer savings account into the electronic gift card usable at both the point of sale environment and the e-commerce environment in response to receiving the redemption indication. The method may further include validating the electronic customer savings account associated with the customer based on the customer identification information. The customer identification information may be at least one of a phone number and a PIN number. The customer identification information may be a QR code. The point of sale environment may be a register at a retail store. The e-commerce environment may be a website of a retail store. The e-commerce environment may be a mobile application of a retail store.

In an embodiment, a system for electronic customer savings redemption from an electronic customer savings account associated with a customer may be provided. The electronic customer savings redemption may be available at both a point of sale environment and an e-commerce environment from the electronic customer savings account. The system may include a graphical user interface at a point of sale environment to provide a customer indication prompting a customer to provide customer identification information usable to identify the electronic customer savings account associated with the customer and to receive a redemption indication indicating that the customer chose to redeem at least a portion of electronic customer savings associated with the electronic customer savings account. The system may further include a cloud-based customer savings redemption system, in communication with the point of sale environment to receive the customer identification information, identify the electronic customer savings account associated with the customer based on the customer identification information, convert the at least a portion of electronic customer savings associated with the electronic customer savings account into an electronic gift card usable at both the point of sale environment and the e-commerce environment, transmit electronic gift card details associated with the electronic gift card to the point of sale environment, and apply the electronic gift card against a transaction for the customer at the point of sale environment.

In an implementation, the electronic customer savings associated with the electronic customer savings account may be accrued from a difference in a first price paid by the customer to a first entity in exchange for a product and a second price offered by a second entity for the product. The difference in the first price and the second price may be the at least a portion of electronic customer savings associated with the electronic customer savings account that may be converted into the electronic gift card usable at both the point of sale environment and the e-commerce environment. The electronic customer savings redemption from the electronic customer savings account may be available at a register in a retail store, a website of the retail store, and a mobile application of the retail store via the electronic gift card.

In an implementation, the cloud-based customer savings redemption system may receive the customer identification information from a mobile device associated with the customer. The customer identification information may be included in a QR code including information usable to identify the electronic customer savings account associated with the customer and convert the at least a portion of electronic customer savings associated with the electronic customer savings account into the electronic gift card usable at both the point of sale environment and the e-commerce environment in response to receiving the redemption indication. Further, the cloud-based customer savings redemption system may validate the electronic customer savings account associated with the customer based on the customer identification information. The customer identification information may be at least one of a phone number and a PIN number.

In an embodiment, a method for electronic customer savings redemption may include receiving a redemption indication via a graphical user interface at a point of sale environment, the redemption indication indicating that a customer chose to redeem at least a portion of electronic customer savings associated with an electronic customer savings account. The method may further include converting, at a cloud-based customer savings redemption system, at least a portion of electronic customer savings associated with the electronic customer savings account into an electronic gift card usable at both the point of sale environment and the e-commerce environment. The electronic customer savings associated with the electronic customer savings account may be accrued from a difference in a first price paid by the customer to a first entity in exchange for a product and a second price offered by a second entity for the product. The method may further include transmitting electronic gift card details associated with the electronic gift card to the point of sale environment and applying the electronic gift card against a transaction for the customer at the point of sale environment. In an implementation, the difference in the first price and the second price may be the at least a portion of electronic customer savings associated with the electronic customer savings account that is converted into the electronic gift card usable at both the point of sale environment and the e-commerce environment.

In an embodiment, a computer program product residing on a computer readable storage medium may have a plurality of instructions stored thereon, which, when executed by a processor, may cause the processor to perform operations for electronic customer savings redemption from an electronic customer savings account associated with a customer, the electronic customer savings redemption available at both a point of sale environment and an e-commerce environment from the electronic customer savings account. The operations may include providing a customer indication via a graphical user interface at the point of sale environment, the point of sale environment in communication with a cloud-based customer savings redemption system and the customer indication prompting a customer to provide customer identification information usable to identify the electronic customer savings account associated with the customer. The operations may further include receiving the customer identification information at the cloud-based customer savings redemption system and identifying the electronic customer savings account associated with the customer based on the customer identification information. The operations may also include receiving a redemption indication via the graphical user interface at the point of sale environment, the redemption indication indicating that the customer chose to redeem at least a portion of electronic customer savings associated with the electronic customer savings account. The operations may additionally include, converting, at the cloud-based customer savings redemption system, the at least a portion of electronic customer savings associated with the electronic customer savings account into an electronic gift card usable at both the point of sale environment and the e-commerce environment. Moreover, the operations include transmitting electronic gift card details associated with the electronic gift card to the point of sale environment and applying the electronic gift card against a transaction for the customer at the point of sale environment.

In an embodiment, a computing system for electronic customer savings redemption from an electronic customer savings account associated with a customer, the electronic customer savings redemption available at both a point of sale environment and an e-commerce environment from the electronic customer savings account, may include one or more processors. The one or more processors may be configured to provide a customer indication via a graphical user interface at the point of sale environment, the point of sale environment in communication with a cloud-based customer savings redemption system and the customer indication prompting a customer to provide customer identification information usable to identify the electronic customer savings account associated with the customer. The one or more processors may be further configured to receive the customer identification information at the cloud-based customer savings redemption system and identifying the electronic customer savings account associated with the customer based on the customer identification information. The one or more processors may also be configured to receive a redemption indication via the graphical user interface at the point of sale environment, the redemption indication indicating that the customer chose to redeem at least a portion of electronic customer savings associated with the electronic customer savings account. The one or more processors may additionally be configured to convert, at the cloud-based customer savings redemption system, the at least a portion of electronic customer savings associated with the electronic customer savings account into an electronic gift card usable at both the point of sale environment and the e-commerce environment. Moreover, the one or more processors may be configured to transmit electronic gift card details associated with the electronic gift card to the point of sale environment and applying the electronic gift card against a transaction for the customer at the point of sale environment.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example system that can execute implementations of the present disclosure;

FIG. 2 illustrates an example process for electronic customer savings redemption in accordance with the present disclosure;

FIG. 3 depicts an example system for electronic customer savings redemption at an e-commerce interface device in accordance with the present disclosure;

FIG. 4 depicts an example system for electronic customer savings redemption at a point of sale environment in accordance with the present disclosure; and

FIG. 5 depicts an example system for electronic customer savings redemption at a point of sale environment and/or mobile device in accordance with the present disclosure.

### DETAILED DESCRIPTION

### Overview

A retailer or other company or business may wish to make alternative sources of funds accessible or more easily accessible for use in point of sale environments so that customers can access those funds and pay for products and services. Systems and methods to facilitate accessibility to alternative sources of funds for use in point of sale environments may be provided in the present disclosure. Further, systems and methods to facilitate accessibility to alternative sources of funds at both point of sale environments as well as e-commerce environments may be provided in the present disclosure.

For example, a savings redeemer system may allow a customer to access savings from a savings catcher account. Assume for illustrative purposes that a customer purchases a product from a first retail store for price X and the same product is available for purchase from a second retail store for price Y, where X>Y. The customer may be enrolled in a savings catcher system provided by the first retail store where the first retail store uses an automated system to determine that the same product is available for purchase from the second retail store for price Y. The savings catcher system may further determine the difference between price X and price Y and apply the difference to a savings catcher account for the customer. The savings catcher account may be an alternative source of funds with which the customer can pay for products and services at the first retail store.

A savings catcher system may reside in or be a component of a retail store application which may run on a server computer as discussed below. The savings catcher system may provide funds or credit to a customer if, for example, another retail store or merchant is selling the product or merchandize for a lower price than the retail store or merchant running the savings catcher system. The savings catcher system may be initiated when a customer scans, for example, a QR code on a sales receipt into, for example, a retail store mobile application. The customer may also attach details of a transaction associated with the sales receipt to the customer's account in the retail store mobile application. A backend of the savings catcher system, which may run at a server computer, may perform operations to evaluate prices of items listed in the receipt with other promotions or pricing of competing retailers or merchants and determine if the price of an item purchased at the retail store running the savings catcher system was higher than a corresponding price for the same item at the competing retailers or merchant. If so, a difference in the prices may be saved and displayed to the customer via, for example, the retail store mobile application. The savings catcher system may accumulate price differences for the customer each time the system finds a price difference for subsequent receipts scanned. The customer may appropriate the accumulated funds and redeem them at the retail store or on a website associated with the retail store, as described below, using the techniques and features of the present disclosure. In an implementation, the customer may have a credit card or savings account associated with the customer's account in the savings catcher system, and the accumulated funds may be added to that account.

Redeeming funds or savings from the savings catcher account may be difficult or cumbersome. For example, redeeming savings from the savings catcher account may require using gift cards which include savings catcher funds in retail stores and may be time consuming or confusing for customers. Using the techniques and features described in the present disclosure, the funds in the savings catcher account may be made accessible or otherwise available for the customer to easily use to pay for products and services at retail stores. The savings catcher account, the point of sale device or environment, and the e-commerce environment may be seamlessly integrated.

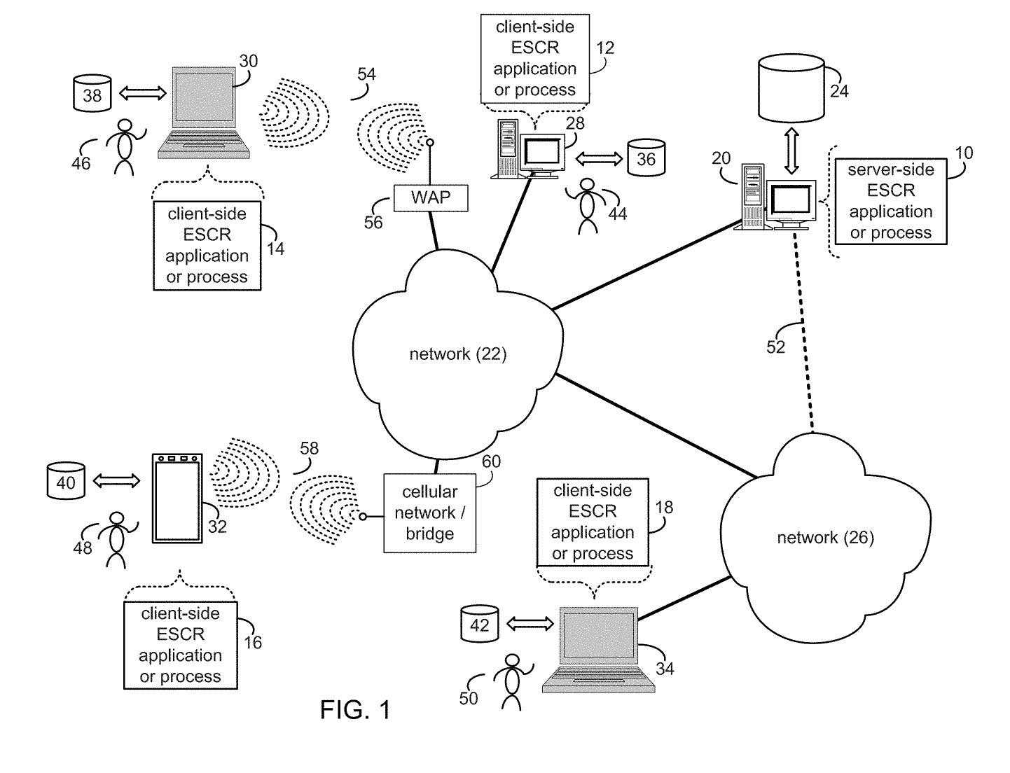

Referring to FIGS. 1 & 2, there is shown a server application 10 and client applications 12, 14, 16, and 18. Server application 10 and/or one or more of client applications 12, 14, 16, and/or 18 may execute one or more processes configured to carry out one or more of the features described herein. Server application 10 may be referred to as a process configured to carry out one or more of the features described herein, such as electronic savings conversion and redemption (ESCR) process 10. Further, one or more of client applications 12, 14, 16, and 18 may be referred to as a process configured to carry out one or more of the features described herein, such as electronic savings conversion and redemption (ESCR) processes 12, 14, 16, and/or 18.

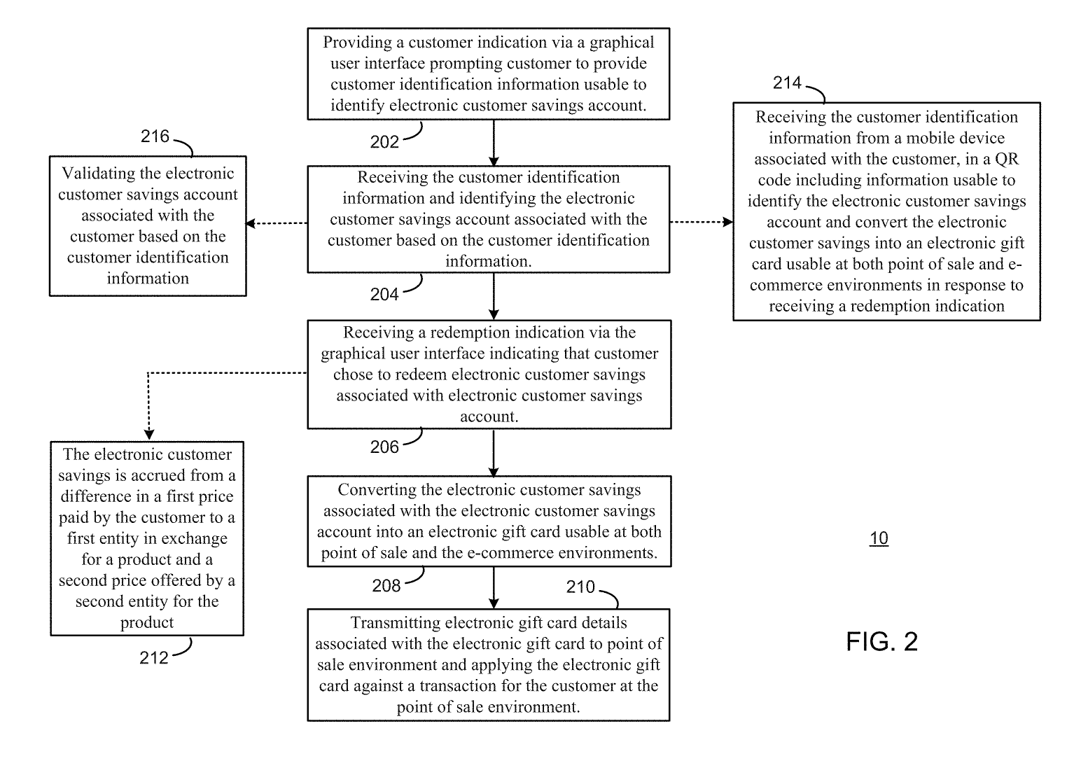

Referring now to FIG. 2, an example ESCR process 10 is shown. ESCR process 10 may provide (202) a customer indication via a graphical user interface prompting a customer to provide customer identification information usable to identify an electronic customer savings account (e.g., a savings catcher account). ESCR process 10 may further include receiving (204) the customer identification information and identifying the electronic customer savings account associated with the customer based on the customer identification information. ESCR process 10 may also include receiving (206) a redemption indication via the graphical user interface indicating that the customer chose to redeem electronic customer savings associated with electronic customer savings account. ESCR process 10 may convert (208) the electronic customer savings associated with the electronic customer savings account into an electronic gift card usable at both point of sale and the e-commerce environments. ESCR process 10 may transmit (210) electronic gift card details associated with the electronic gift card to a point of sale environment and apply the electronic gift card against a transaction for the customer at the point of sale environment.

The ESCR process may be a server-side process (e.g., server-side ESCR process 10), a client-side process (e.g., client-side ESCR process 12, client-side ESCR process 14, client-side ESCR process 16, or client-side ESCR process 18), or a hybrid server-side/client-side process (e.g., a combination of server-side ESCR process 10 and one or more of client-side ESCR processes 12, 14, 16, 18).

### System Overview

Referring to FIG. 1, server-side ESCR process 10 may reside on and may be executed by server computer 20, which may be in communication with network 22 (e.g., the Internet or a local area network). Examples of server computer 20 may include, but are not limited to: a personal computer, a server computer, a series of server computers, a mini computer, and/or a mainframe computer. The server computer 20 may be a distributed system and the operations of the server computer 20 may execute on one or more processors, simultaneously and/or serially. For example, server computer 20 may be a symbolic representation of a cloud computing site, cloud environment, or cloud platform running multiple servers, computers, or virtual machines. Server computer 20 may execute one or more operating systems, examples of which may include but are not limited to: Microsoft Windows Server™; Novell Netware™; Redhat Linux™, Unix, or a custom operating system, for example.

For example, server computer 20 may be a symbolic representation of a cloud-based customer savings redemption system or server suitable for performing the operations described in the present disclosure. In an implementation, server computer 20 may be a cloud-based customer savings redemption system or server which may include, store, run, and/or execute ESCR process 10. The cloud-based customer savings redemption system or server may be part of a network of servers and other computing devices administered by a company or business that uses ESCR process 10, such as a retailer or physical store having employees or associates.

The instruction sets and subroutines of server-side ESCR process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a solid state storage device; a RAID array; a random access memory (RAM); and a read-only memory (ROM).

Server computer 20 may execute a web server application that allows for access to server computer 20 (via network 22) using one or more protocols, examples of which may include but are not limited to HTTP (i.e., HyperText Transfer Protocol). Network 22 may be in communication with one or more secondary networks (e.g., network 26), examples of which may include but are not limited to: a local area network; a wide area network; or an intranet, for example.

Client-side ESCR processes 12, 14, 16, 18 may reside on and may be executed by client electronic devices 28, 30, 32, and/or 34 (respectively), examples of which may include but are not limited to personal computer 28, a television with one or more processors embedded therein or coupled thereto (not shown), laptop computer 30, data-enabled mobile telephone or smartphone 32, notebook computer 34, a tablet (not shown), and a personal digital assistant (not shown), for example. Client electronic devices 28, 30, 32, and/or 34 may each be in communication with network 22 and/or network 26 and may each execute an operating system, examples of which may include but are not limited to Apple iOS™, Microsoft Windows™, Android™, Redhat Linux™, or a custom operating system.

In an implementation, one or more of client electronic devices 28, 30, 32, and/or 34 may be associated with a customer of the company or business that uses one or more of ESCR process 10, 12, 14, 16, and/or 18 such as a retailer or physical store having customers. For example, data-enabled mobile telephone 32 may be a mobile device such as a smartphone associated with a customer.

The instruction sets and subroutines of client-side ESCR processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; solid state storage devices; RAID arrays; random access memories (RAM); read-only memories (ROM); compact flash (CF) storage devices; secure digital (SD) storage devices; and memory stick storage devices.

Client-side ESCR processes 12, 14, 16, 18 and/or server-side ESCR process 10 may be processes that run within (i.e., are part of) a cloud computing site, cloud computing application, cloud platform, or cloud environment. Alternatively, client-side ESCR processes 12, 14, 16, 18 and/or server-side ESCR process 10 may be stand-alone applications that work in conjunction with the cloud computing site, cloud computing application, cloud platform, or cloud environment. One or more of client-side ESCR processes 12, 14, 16, 18 and server-side ESCR process 10 may interface with each other (via network 22 and/or network 26).

Users 44, 46, 48, 50 may access server-side ESCR process 10 directly through the device on which the client-side ESCR process (e.g., client-side ESCR processes 12, 14, 16, 18) is executed, namely client electronic devices 28, 30, 32, 34, for example. Users 44, 46, 48, 50 may access server-side ESCR process 10 directly through network 22 and/or through secondary network 26. Further, server computer 20 (i.e., the computer that executes server-side ESCR process 10) may be in communication with network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing a wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

### Electronic Savings Conversion and Redemption (ESCR) Process

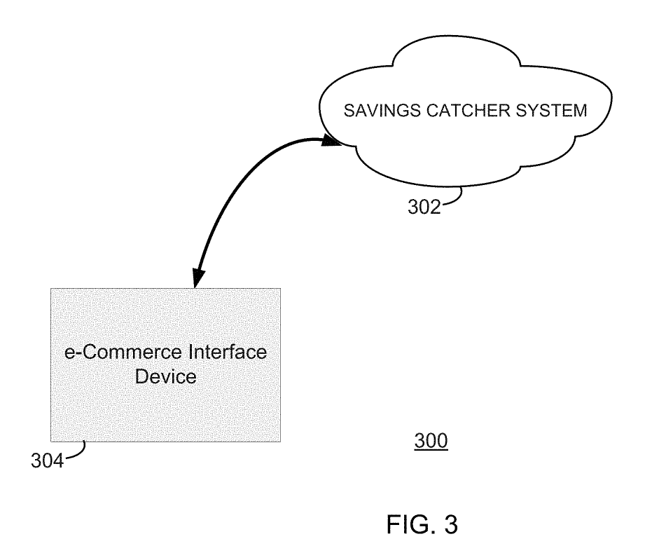

For the following discussion, server-side ESCR process 10 will be described for illustrative purposes. It should be noted that server-side ESCR process 10 may interact with client-side ESCR process 12 and may be executed within one or more applications that allow for communication with client-side ESCR process 12. However, this is not intended to be a limitation of this disclosure, as other configurations are possible (e.g., stand-alone, client-side ESCR processes and/or stand-alone server-side ESCR processes). For example, some implementations may include one or more of client-side ESCR processes 12, 14, 16, and/or 18 in place of or in addition to server-side ESCR process 10. Further, all or parts of ESCR process 10 and/or ESCR processes 12, 14, 16, and/or 18 may be run or executed by one or more of the components of systems 300, 400, and/or 500 of FIGS. 3, 4, and 5, respectively, such as savings catcher systems 302, 402, and 502, e-commerce interface device 304, point of sale environments 404 and 504, savings redemption systems 406, and 506, and mobile device 508.

The methods and systems described in the present disclosure may be implemented to provide a service from a savings catcher system to a point of sale environment or device to provide a balance of a savings catcher account for a customer. The customer may be identified via a mobile phone or mobile device application or by using the customer's phone number at the point of sale environment or device to look up the customer's account. Further, using the methods and systems described in the present disclosure, the customer's savings catcher account balance may be used as a cash-like tender at the point of sale environment or device.

Referring now to FIG. 3, a system 300 for electronic consumer savings redemption is shown. An e-commerce environment may include e-commerce interface device 304 (e.g., one or more of client electronic devices 28, 30, 32, and/or 34). System 300 may also include an electronic savings catcher system 302 which may be administered by a retail store and may manage electronic savings catcher accounts of customers of the retail store. In an implementation, a customer's savings catcher account balance may be made available as a cash-like tender that the customer may apply towards e-commerce transactions over the Internet. The customer may use his/her credentials to check-out on a sales webpage associated with the retail store, and the customer's savings catcher account balance may be linked to his/her retail store customer account for check-out purposes such that the customer's savings catcher account balance may be applied towards e-commerce transactions over the Internet.

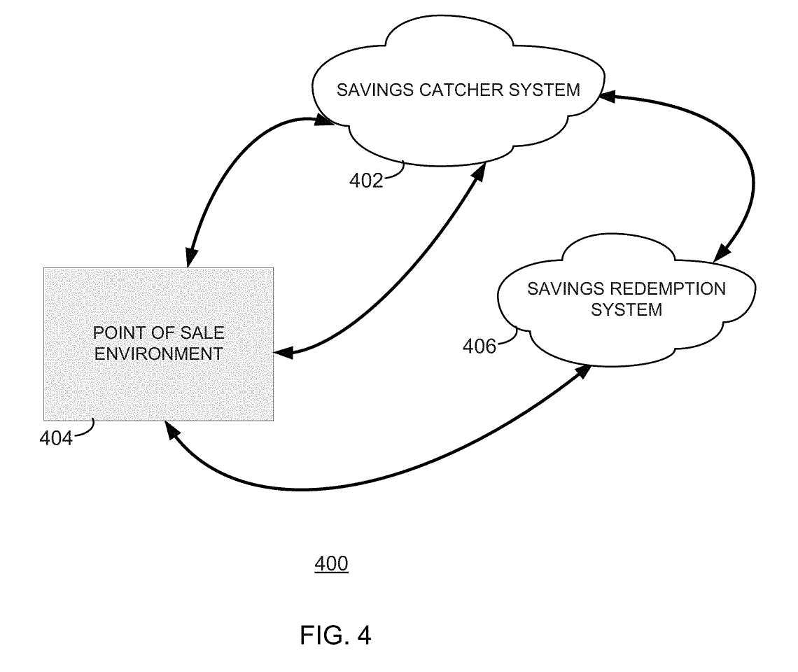

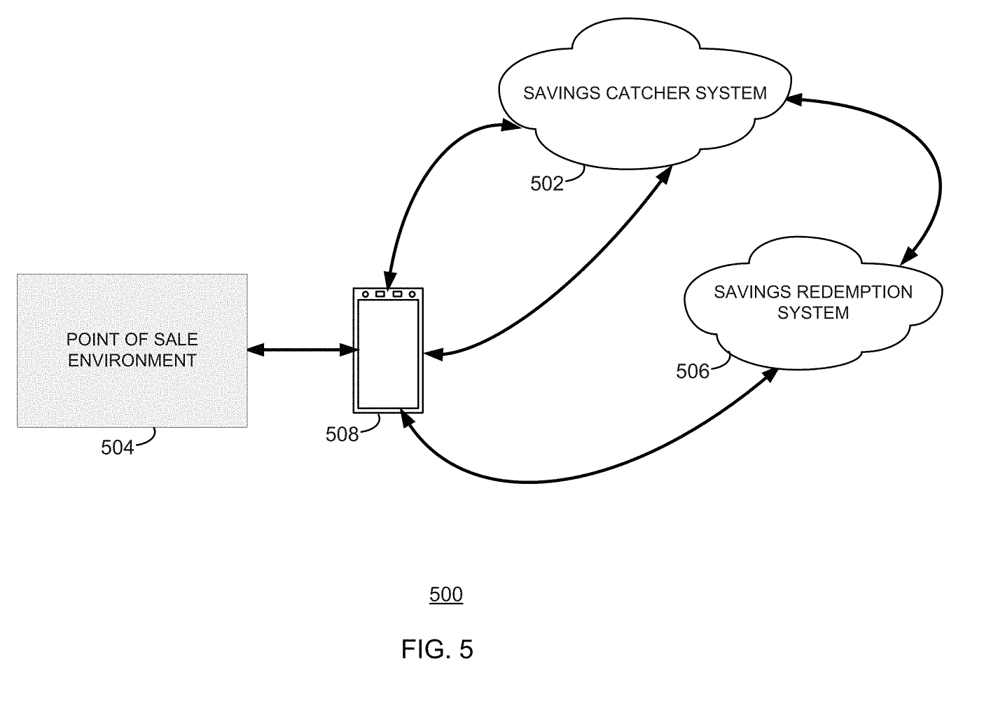

Referring to FIGS. 1 and 2, in an embodiment, methods for electronic customer savings redemption from an electronic customer savings account, also referred to as a savings catcher account, associated with a customer may be provided and may be implemented via ESCR process 10. Electronic customer savings redemption may be available via ESCR process 10 at both a point of sale environment (e.g., as shown in systems 400 and 500 of FIGS. 4 and 5, respectively) and an e-commerce environment (e.g., as shown in system 300 of FIG. 3) from the electronic customer savings account. In an implementation, the e-commerce environment may be a retail store mobile payment application associated with the retail store.

Referring also to FIG. 4, ESCR process 10 may provide (202) a customer indication via a graphical user interface at point of sale environment 404. Point of sale environment 404 may include or may be one or more of a point of sale device, a cash register device, a payment card interface device, a self-service payment device, a mobile processing system, and/or a mobile device payment processing application. Point of sale environment 404 may be in communication with customer savings redemption system 406 which may be cloud-based. The customer indication may prompt a customer to provide customer identification information usable to identify the electronic customer savings account (e.g., savings catcher account) associated with the customer. For example, point of sale environment 404 may be a cash register device which may prompt the customer to enter the customer's phone number and/or personal identification number (PIN) to identify the customer in savings catcher system 402 and/or customer savings redemption system 406.

Referring now also to FIG. 5, in an implementation, ESCR process 10 may receive (214) the customer identification information from mobile device 508 associated with the customer. The customer identification information may be included in a QR code. The QR code may include information usable to identify the electronic customer savings account associated with the customer. The QR code may also be usable to convert or provide information necessary to convert the portion of electronic customer savings associated with the electronic customer savings account (e.g., savings catcher account) into the electronic gift card. The electronic gift card may be usable at both point of sale environment 504 and an e-commerce environment (e.g., e-commerce interface device 304) in response to receiving an indication to redeem. The customer identification information itself may be a QR code.

The electronic customer savings account may be a savings catcher account (as described above) administered via electronic savings catcher system 402. It should be noted that while electronic savings catcher system 402 and customer savings redemption system 406 are shown separately in FIG. 4, in various implementations electronic savings catcher system 402 and customer savings redemption system 406 may be part of a single system which may be cloud-based and may perform any of the operations described herein as being performed by electronic savings catcher system 402 or customer savings redemption system 406.

The customer may provide the customer identification information usable to identify the electronic customer savings account associated with the customer via the graphical user interface at point of sale environment 404. Continuing with the example above, the cash register device (i.e., point of sale environment 404) may transmit the customer identification information to electronic savings catcher system 402 and/or customer savings redemption system 406. ESCR process 10 may receive (204) the customer identification information at cloud-based customer savings redemption system 406 and may identify the electronic customer savings account associated with the customer based on the customer identification information (e.g., phone number or PIN). In an implementation, ESCR process 10 may validate (216) the electronic customer savings account associated with the customer based on the customer identification information. Further, in an implementation, electronic savings catcher system 402 may transmit a reply to point of sale environment 404 with an acknowledgment and a validation of the customer.

In an implementation, the electronic customer savings account associated with the customer may be validated using a telephone or mobile phone number and PIN combination. For example, ESCR process 10 may recognize or identify the customer based on the telephone or mobile phone number and PIN combination and may display a balance in the electronic customer savings account associated with the customer. ESCR process 10 may cross reference the customer's phone number and PIN with an existing account which may have been set up prior to use of the retail store mobile application or savings catcher system. In an implementation, if the customer is not set up in the savings catcher system or the phone number and PIN combination is incorrect or not found, ESCR process 10 may display an error denoting the credentials are not valid and may ask the customer to try again or look up their credential details in the retail store mobile application or at a website of the retail store. If the customer's credentials are valid, ESCR process 10 may provide a confirmation (e.g., at the point of sale environment) that the customer has been validated. Electronic savings catcher system 402 may also transmit an existing balance of accrued saving catcher credit in the electronic customer savings account or savings catcher account.

The customer may provide a redemption indication via the graphical user interface at point of sale environment 404. The customer may choose (at the graphical user interface) to redeem some or all of the existing balance in the electronic customer savings account (e.g., savings catcher account) and may indicate an amount to redeem (e.g., to apply towards a transaction). For example, the cash register device of point of sale environment 404 may transmit the amount indicated by the customer to customer savings redemption system 406. ESCR process 10 may receive (206) the redemption indication via the graphical user interface at the point of sale environment. In other words, the redemption indication may indicate that the customer chose to redeem at least a portion of electronic customer savings (i.e., the balance) associated with the electronic customer savings account (e.g., savings catcher account).

In an implementation, the electronic customer savings (i.e., the balance) in the electronic customer savings account (e.g., savings catcher account) may be accrued (212) from a difference in a first price paid by the customer to a first entity (e.g., the retail store) in exchange for a product and a second price offered by a second entity (e.g., another retail store) for the product. For example, the savings catcher system may compare a price paid for an item at the retail store with prices offered for the item at retailers listed in a pre-defined list and provide a difference between the process paid and the lowest price match to the customer via the savings catcher account.

ESCR process 10 may convert (208), at cloud-based customer savings redemption system 406 (or in various implementations, in, electronic savings catcher system 402), the portion of electronic customer savings associated with the electronic customer savings account into an electronic gift card. The portion of electronic savings may be the amount the customer chose to redeem via the graphical user interface as described above. The electronic gift card may be usable at both point of sale environment 404 and e-commerce interface device 304. In an implementation, savings redemption system 406 may interact and exchange data with savings catcher system 402 to convert the electronic customer savings account or savings catcher account balance (or portion thereof) to an electronic gift card.

As discussed above, the electronic customer savings associated with the electronic customer savings account (e.g., savings catcher account) may be accrued from a difference in a first price paid by the customer to the retail store in exchange for a product and a second price offered by another retail store for the product. In an implementation, the difference in the first price and the second price may be the portion of the electronic customer savings associated with the electronic customer savings account (e.g., savings catcher account) that is converted into the electronic gift card.

For example, the savings catcher system may accrue savings determined from store sales captured via a QR scan of a QR code associated with a receipt. The QR code may be scanned into a retail store mobile application via a smartphone. The savings catcher system may determine differences between sales prices at the retail store and competing prices at other retail stores. The savings catcher system may allow the customer to place the value of the accrued savings in the savings catcher account into an electronic gift card or a credit card or savings account through the retail store mobile application.

In an implementation, the savings redemption system may perform operations at the point of sale environment to convert the accrued value into an electronic gift card. The customer interaction with savings redemption system may be at the point of sale environment during another transaction within the retail store or on the retail store mobile application or retail store website, rather than within a savings catcher application. Any outstanding balance of the savings catcher account not already added or converted to an electronic gift card at the time the customer presents his or her credentials at the point of sale environment may be automatically converted to an electronic gift card. The electronic gift card details may be presented at the point of sale environment via the savings redemption system.

Savings catcher system 402 may transmit electronic gift card details associated with the electronic gift card to savings redemption system 406. Further, ESCR process 10 may transmit 210 electronic gift card details associated with the electronic gift card to point of sale environment 404 and apply the electronic gift card against a transaction for the customer at point of sale environment 404. In an implementation, the electronic customer savings redemption from the electronic customer savings account (e.g., savings catcher balance) may be available at a register (i.e., cash register device at the point of sale environment) in a retail store, a website of the retail store, and a mobile application of the retail store, via the electronic gift card.

In an implementation, ESCR process 10 may carry out one or more operations to achieve electronic customer savings redemption when a customer uses a mobile device at a point of sale environment. Referring to FIG. 5, a cash register device at point of sale environment 504 may prompt the customer to scan a QR code at point of sale environment 504 with the customer's mobile phone or mobile device 508 to identify the customer. The customer may be identified in a retail store mobile payment application. The retail store mobile payment application may identify the customer and check the customer's electronic customer savings account balance (e.g., savings catcher balance) at savings catcher system 502. Savings catcher system 502 may transmit a reply which may include an acknowledgment, validation of the customer, and existing balance of accrued electronic customer savings or savings catcher credit to the retail store mobile payment application.

The retail store mobile payment application may run on one or more of client electronic devices 28, 30, 32, and/or 34. The retail store mobile payment application may be referred to, may be part of, or may have common functionality with a retail store mobile application. A retail store mobile payment application or system may operate in cooperation with a point of sale system or environment or may be a point of sale system or environment in and of itself. The retail store mobile payment application may utilize a telephone or mobile phone number and PIN number of a customer to identify the customer and provide customer savings catcher account information. The retail store mobile payment application may perform operations to allow the customer to use his or her balance in the savings catcher account. The customer may redeem his or her balance for a present transaction or save it for future use.

Further, the customer may choose to redeem the electronic customer savings account balance (e.g., savings catcher balance) via the retail store payment mobile application and/or mobile device 508. The retail store mobile payment application and/or mobile device 508 transmit an amount that the customer chose to redeem to the savings redemption system 506. The savings redemption system 506 may interact with electronic savings catcher system 502 to convert the electronic customer savings account balance (e.g., savings catcher balance) to an electronic gift card, as discussed above.

Electronic savings catcher system 502 may transmit electronic gift card details associated with the electronic gift card to savings redemption system 506. Savings redemption system 506 may transmit the electronic gift card details to the retail store mobile payment application and/or mobile device 508, which may be in communication with the cash register device at point of sale environment 504. The cash register device may use the electronic gift card as tender against a transaction for the customer at the retail store. The cash register device may conclude the transaction as if a physical electronic gift card was presented directly at the cash register device by the customer, or was presented directly at the cash register device by the customer via the retail store mobile payment application.

As described above, the techniques and features described in the present disclosure may facilitate electronic customer savings redemption from an electronic customer savings account or savings catcher account associated with a customer. Using the techniques and features described in the present disclosure, the retailer may implement a system for facilitating electronic customer savings redemption from the electronic customer savings account associated with the customer.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by, or to control the operation of, a data processing apparatus. The computer readable medium can be a machine-readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions or computer program products and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These may also be referred to as computer readable storage media. The processor and the memory can be supplemented by, or incorporated in, special purpose logic circuitry.

To provide for interaction with a user, implementations of described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

A number of embodiments and implementations have been described. Nevertheless, it will be understood that various modifications may be made. Accordingly, other embodiments and implementations are within the scope of the following claims. For example, the actions recited in the claims can be performed in a different order and still achieve desirable results.

What is claimed is:

1. A method for electronic customer savings redemption from an electronic customer savings account associated with a customer, the electronic customer savings redemption available at both a point of sale environment and an e-commerce environment from the electronic customer savings account, the method comprising:
providing a customer indication via a graphical user interface at the point of sale environment, the point of sale environment in communication with a cloud-based customer savings redemption system and the customer indication prompting a customer to provide customer identification information usable to identify the electronic customer savings account associated with the customer;
receiving the customer identification information at the cloud-based customer savings redemption system and identifying the electronic customer savings account associated with the customer based on the customer identification information;
receiving a redemption indication via the graphical user interface at the point of sale environment, the redemption indication indicating that the customer chose to redeem at least a portion of electronic customer savings associated with the electronic customer savings account;
converting, at the cloud-based customer savings redemption system, the at least a portion of electronic customer savings associated with the electronic customer savings account into an electronic gift card usable at both the point of sale environment and the e-commerce environment; and
transmitting electronic gift card details associated with the electronic gift card to the point of sale environment and applying the electronic gift card against a transaction for the customer at the point of sale environment.

2. The method of claim 1, wherein the electronic customer savings associated with the electronic customer savings account are accrued from a difference in a first price paid by the customer to a first entity in exchange for a product and a second price offered by a second entity for the product.

3. The method of claim 2, wherein the difference in the first price and the second price is the at least a portion of electronic customer savings associated with the electronic customer savings account that is converted into the electronic gift card usable at both the point of sale environment and the e-commerce environment.

4. The method of claim 1, wherein the electronic customer savings redemption from the electronic customer savings account is available at a register in a retail store, a website of the retail store, and a mobile application of the retail store via the electronic gift card.

5. The method of claim 1, further comprising:
receiving the customer identification information from a mobile device associated with the customer, the customer identification information being included in a QR code including information usable to identify the electronic customer savings account associated with the customer and convert the at least a portion of electronic customer savings associated with the electronic customer savings account into the electronic gift card usable at both the point of sale environment and the e-commerce environment in response to receiving the redemption indication.

6. The method of claim 1, further comprising:
validating the electronic customer savings account associated with the customer based on the customer identification information.

7. The method of claim 1, wherein the customer identification information is at least one of a phone number and a PIN number.

8. The method of claim 1, wherein the customer identification information is a QR code.

9. The method of claim 1, wherein the point of sale environment is a register at a retail store.

10. The method of claim 1, wherein the e-commerce environment is a website of a retail store.

11. The method of claim 1, wherein the e-commerce environment is a mobile application of a retail store.

12. A system for electronic customer savings redemption from an electronic customer savings account associated with a customer, the electronic customer savings redemption available at both a point of sale environment and an e-commerce environment from the electronic customer savings account, the system comprising:
a graphical user interface at a point of sale environment to provide a customer indication prompting a customer to provide customer identification information usable to identify the electronic customer savings account associated with the customer and to receive a redemption indication indicating that the customer chose to redeem at least a portion of electronic customer savings associated with the electronic customer savings account;
a cloud-based customer savings redemption system, in communication with the point of sale environment to receive the customer identification information, identify the electronic customer savings account associated with the customer based on the customer identification information, convert the at least a portion of electronic customer savings associated with the electronic customer savings account into an electronic gift card usable at both the point of sale environment and the e-commerce environment, transmit electronic gift card details associated with the electronic gift card to the point of sale environment, and apply the electronic gift card against a transaction for the customer at the point of sale environment.

13. The system of claim 12, wherein the electronic customer savings associated with the electronic customer savings account are accrued from a difference in a first price paid by the customer to a first entity in exchange for a product and a second price offered by a second entity for the product.

14. The system of claim 13, wherein the difference in the first price and the second price is the at least a portion of electronic customer savings associated with the electronic customer savings account that is converted into the electronic gift card usable at both the point of sale environment and the e-commerce environment.

15. The system of claim 12, wherein the electronic customer savings redemption from the electronic customer savings account is available at a register in a retail store, a website of the retail store, and a mobile application of the retail store via the electronic gift card.

16. The system of claim 12, wherein the cloud-based customer savings redemption system receives the customer identification information from a mobile device associated with the customer, the customer identification information being included in a QR code including information usable to identify the electronic customer savings account associated with the customer and convert the at least a portion of electronic customer savings associated with the electronic customer savings account into the electronic gift card usable at both the point of sale environment and the e-commerce environment in response to receiving the redemption indication.

17. The system of claim 12, wherein the cloud-based customer savings redemption system validates the electronic customer savings account associated with the customer based on the customer identification information.

18. The system of claim 12, wherein the customer identification information is at least one of a phone number and a PIN number.

19. A method for electronic customer savings redemption, method comprising:
receiving a redemption indication via a graphical user interface at a point of sale environment, the redemption indication indicating that a customer chose to redeem at least a portion of electronic customer savings associated with an electronic customer savings account;
converting, at a cloud-based customer savings redemption system, at least a portion of electronic customer savings associated with the electronic customer savings account into an electronic gift card usable at both the point of sale environment and the e-commerce environment, wherein the electronic customer savings associated with the electronic customer savings account are accrued from a difference in a first price paid by the customer to a first entity in exchange for a product and a second price offered by a second entity for the product; and
transmitting electronic gift card details associated with the electronic gift card to the point of sale environment and applying the electronic gift card against a transaction for the customer at the point of sale environment.

20. The method of claim 19, wherein the difference in the first price and the second price is the at least a portion of electronic customer savings associated with the electronic customer savings account that is converted into the electronic gift card usable at both the point of sale environment and the e-commerce environment.
